(19) United States
(12) Patent Application Publication
(10) Pub. No.: US 2025/0144950 A1
(43) Pub. Date: May 8, 2025

(54) DIGITAL PRINTING MACHINE NOZZLE REFRIGERATING DEVICE AND USING METHOD THEREOF

(71) Applicant: Zhejiang Furun Dyeing and Printing Co., Ltd, Shaoxing (CN)

(72) Inventors: Yifeng WANG, Shaoxing (CN); Ke ZHOU, Shaoxing (CN); Liumei ZHANG, Shaoxing (CN)

(73) Assignee: Zhejiang Furun Dyeing and Printing Co., Ltd, Shaoxing (CN)

(21) Appl. No.: 18/903,244

(22) Filed: Oct. 1, 2024

Related U.S. Application Data
(63) Continuation of application No. PCT/CN2023/131174, filed on Nov. 13, 2023.

(30) Foreign Application Priority Data
Nov. 8, 2023 (CN) 202311479955.5

(51) Int. Cl. B41J 29/377

(52) U.S. Cl. CPC B41J 29/377

(57) ABSTRACT

Disclosed are a digital printing machine nozzle refrigerating device and a using method thereof. The digital printing machine nozzle refrigerating device includes a base and a nozzle disposed on the base, where a water-cooling system and a constant-temperature adjusting system are covered outside the nozzle, the water-cooling system includes a water-cooling side plate and a plurality of water-cooling horizontal bars, the plurality of water-cooling horizontal bars are divided into two parts and horizontally disposed on both sides of the water-cooling side plate, the vertical water-cooling horizontal bars are arranged at intervals, and look-down sections of the water-cooling side plate and the water-cooling horizontal bars on both sides are U-shaped; and the constant-temperature adjusting system includes a constant-temperature side plate and a plurality of constant-temperature horizontal bars, the plurality of constant-temperature horizontal bars are divided into two parts and horizontally disposed on both sides of the constant-temperature side plate.

### CROSS-REFERENCE TO RELATED APPLICATION

The application is a continuation of International Application No. PCT/CN2023/131174, filed on Nov. 13, 2023, which claims priority to Chinese Patent Application CN202311479955.5, filed on Nov. 8, 2023. All of the aforementioned applications are incorporated herein by reference in their entireties.

### TECHNICAL FIELD

The present disclosure relates to the technical field of constant temperature refrigeration of digital printing machine nozzles, and in particular to a digital printing machine nozzle refrigerating device and a using method thereof.

### BACKGROUND

Ink-jet printing is a printing method that an image is digitally entered into a computer, edited through computer software, and then the computer controls a nozzle to directly jet printing ink onto a textile to form the image. The ink-jet printing is non-contact printing, a transformation of the printing technology, and a revolution of the printing industry.

Currently, when the digital nozzle of the ink-jet printing machine works continuously for a long time, the temperature of the nozzle will also continue to rise. The superposition of these two factors will frequently enable the temperature of the digital nozzle to reach 60-70° C., the too high nozzle temperature will affect the quality of the printing ink, thus reducing the printing quality, and seriously, the too high nozzle temperature will damage the nozzle.

Some digital nozzle cooling devices are available currently on the market, for example, Chinese Patent Publication No.CN219650844U provides a refrigerating device for a jet printing system of an independent digital printing machine, including “a heat dissipation plate which wraps and is attached to the periphery of a nozzle, a channel used for cooling media is arranged in the heat dissipation plate, the heat dissipation plate is divided into two layers, the cooling media introduced to the inner layer are condensed steam, the cooling media introduced to the outer layer are cooling water, ink is guided into the nozzle through an ink guide pipe, the periphery of the ink guide pipe is wrapped by a circle of guide pipe, cooling water is introduced into the guide pipe and extends to the leading edge of the introduction nozzle of the ink guide pipe all the way . . . ”

Although the above refrigerating device can cool the digital nozzle, the continuity of refrigeration and fast and slow working efficiency of the digital nozzle lead to the unstable temperature of the digital nozzle; however the unstable temperature will lead to a chromatic aberration and other influences of the printing quality of the printing ink, and high-quality and expected patterns and colors can be printed only as long as the nozzle temperature is kept at a suitable normal temperature. However, how to keep the nozzle temperature has become an urgent problem to be solved at this stage, and to this end, this solution is proposed.

### SUMMARY

For the deficiencies in the prior art, the present disclosure provides a digital printing machine nozzle refrigerating device and a using method thereof, to solve the problem proposed in the background art.

To achieve the above purpose, the present disclosure is implemented by the following technical solution: a digital printing machine nozzle refrigerating device and a using method thereof, including a base and a nozzle disposed on the base, where a water-cooling system and a constant-temperature adjusting system are covered outside the nozzle, the water-cooling system includes a water-cooling side plate and a plurality of water-cooling horizontal bars, the plurality of water-cooling horizontal bars are divided into two parts and horizontally disposed on both sides of the water-cooling side plate, the vertical water-cooling horizontal bars are arranged at intervals, and look-down sections of the water-cooling side plate and the water-cooling horizontal bars on both sides are U-shaped; the constant-temperature adjusting system includes a constant-temperature side plate and a plurality of constant-temperature horizontal bars, the plurality of constant-temperature horizontal bars are divided into two parts and horizontally disposed on both sides of the constant-temperature side plate, the vertical constant-temperature horizontal bars are arranged at intervals, and look-down sections of the constant-temperature side plate and the constant-temperature horizontal bars on both sides are U-shaped; and the water-cooling horizontal bars and the constant-temperature horizontal bars can be mutually plugged into each other's gaps, a water circulation assembly is disposed in the water-cooling horizontal bars, the constant-temperature horizontal bars are internally provided with vacuum pipes along length directions thereof, a constant-temperature adjusting assembly is disposed on the base, and the constant-temperature adjusting assembly is used for adjusting the amount of a liquid metal material squeezed into the vacuum pipes.

Preferably, the constant-temperature adjusting assembly includes a cylinder body, a piston slidingly fitted in the cylinder body, and an electric push rod; and the cylinder body is connected with a main pipe of the vacuum pipes, the liquid metal material is filled in the cylinder body, and the electric push rod is disposed on the cylinder body and connected with the piston.

Preferably, surfaces that the exteriors of the constant-temperature horizontal bars are in contact with the water-cooling horizontal bars and the nozzle are provided with heat dissipation fins.

Preferably, the water circulation assembly includes a water tank and a circulating pump, the water-cooling horizontal bars are internally provided with cooling water pipes along length directions thereof, a plurality of cooling water pipes are serially connected, a water inlet pipe and a water outlet pipe that are connected with heads and tails of the cooling water pipes are disposed on the water-cooling side plate, the water tank, circulating pump and water inlet pipe are serially connected in turn, and the water outlet pipe is connected with the water tank.

Preferably, an air-cooling system is covered outside the water-cooling system and the constant-temperature adjusting system, the air-cooling system includes an annular air cavity and an air pump, the air cavity is annularly covered outside the water-cooling horizontal bars and the constant-temperature horizontal bars, an air inlet and an air outlet are provided on the air cavity, and the air pump is connected with the air inlet.

Preferably, the liquid metal material is a gallium-base alloy.

The present disclosure provides a digital printing machine nozzle refrigerating device and a using method thereof. The present disclosure has the following beneficial effects.

According to the digital printing machine nozzle refrigerating device and the using method thereof, the water-cooling system undertakes a half of cooling power and the constant-temperature adjusting system undertakes the other half of cooling power, the heat transfer power is controlled by changing heat transfer medium amounts in the vacuum pipes, such that the overall cooling power of the nozzle is controlled in a suitable normal temperature area, thus providing a guarantee to the nozzle to print high-quality patterns and colors.

### BRIEF DESCRIPTION OF THE DRAWINGS

FIG. 1 is an overall assembly drawing of an exterior in the present disclosure.

FIG. 2 is an assembly drawing of a water-cooling system and a constant-temperature adjusting system in the present disclosure.

FIG. 3 is a disassembly drawing of a water-cooling system and a constant-temperature adjusting system in the present disclosure.

FIG. 4 is a look-down sectional drawing of a water-cooling system and a constant-temperature adjusting system in the present disclosure.

FIG. 5 is a use flowchart of a digital printing machine nozzle refrigerating device in the present disclosure.

### DETAILED DESCRIPTION OF THE EMBODIMENTS

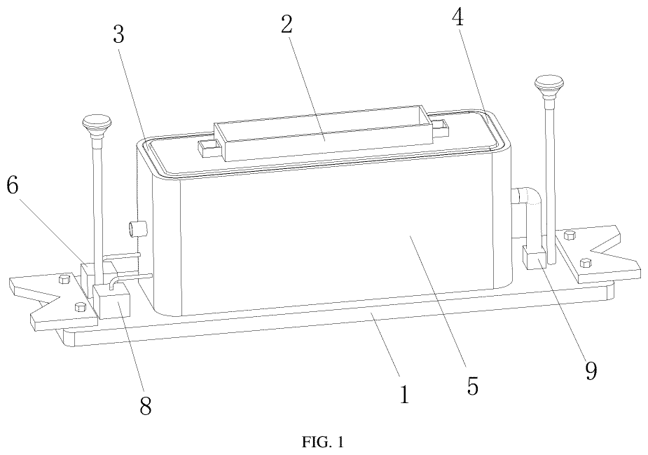

Embodiments of the present disclosure provide a digital printing machine nozzle refrigerating device and a using method thereof, as shown in FIGS. 1-4, the digital printing machine nozzle refrigerating device includes a base 1 and a nozzle 2 disposed on the base 1, where a water-cooling system 3 and a constant-temperature adjusting system 4 are covered outside the nozzle 2.

A temperature measuring module (electrically connected with a controller and at least including a processor and a memory communicatively connected with the processor) is provided on the nozzle 2, to acquire a temperature of the nozzle 2, and the temperature measuring module may be a temperature sensor. When the temperature of the nozzle 2 is greater than or less than a preset value, the temperature of the nozzle 2 is adjusted by adjusting the constant-temperature adjusting system 4. The water-cooling system 3 undertakes a half of cooling power and the constant-temperature adjusting system 4 undertakes the other half of cooling power, the heat transfer power is controlled through the constant-temperature adjusting system 4, such that the overall cooling power of the nozzle is controlled in a suitable normal temperature area, thus providing a guarantee to the nozzle to print high-quality patterns and colors.

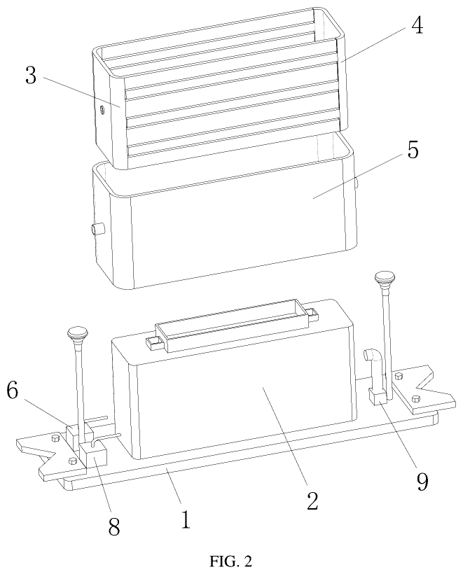

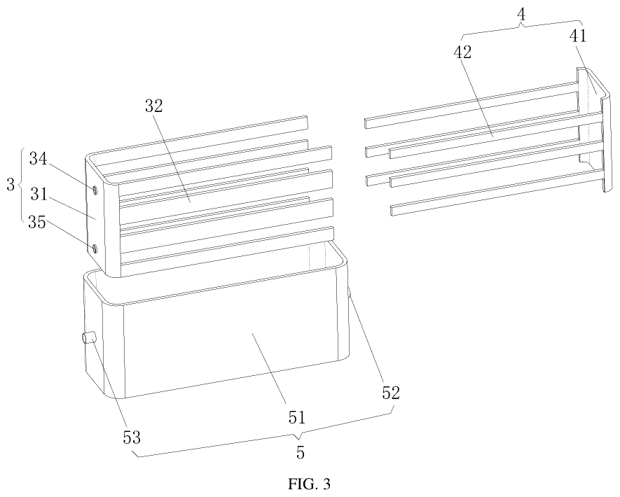

Specifically, as shown in FIGS. 2-3, the overall look-down shape of the water-cooling system 3 is U-shaped, the water-cooling system 3 includes a water-cooling side plate 31 and a plurality of water-cooling horizontal bars 32, the plurality of water-cooling horizontal bars 32 are divided into two parts and horizontally disposed on both sides of the water-cooling side plate 31, the vertical water-cooling horizontal bars 32 are arranged at intervals, and look-down sections of the water-cooling side plate 31 and the water-cooling horizontal bars 32 on both sides are U-shaped; and the constant-temperature adjusting system 4 includes a constant-temperature side plate 41 and a plurality of constant-temperature horizontal bars 42, the plurality of constant-temperature horizontal bars 42 are divided into two parts and horizontally disposed on both sides of the constant-temperature side plate 41, the vertical constant-temperature horizontal bars 42 are arranged at intervals, and look-down sections of the constant-temperature side plate 41 and the constant-temperature horizontal bars 42 on both sides are U-shaped.

A distance between the vertical adjacent water-cooling horizontal bars 32 is slightly greater than a width of each constant-temperature horizontal bar 42, and a distance between the vertical adjacent constant-temperature horizontal bars 42 is slightly greater than a width of each water-cooling horizontal bar 32. The water-cooling horizontal bars 32 and the constant-temperature horizontal bars 42 can be mutually plugged into each other's gaps, the water-cooling side plate 31, the plurality of water-cooling horizontal bars 32, the constant-temperature side plate 41 and the plurality of constant-temperature horizontal bars 42 combine a ring shape to be wrapped outside the nozzle 2, and a water circulation assembly is disposed in the water-cooling horizontal bars 32.

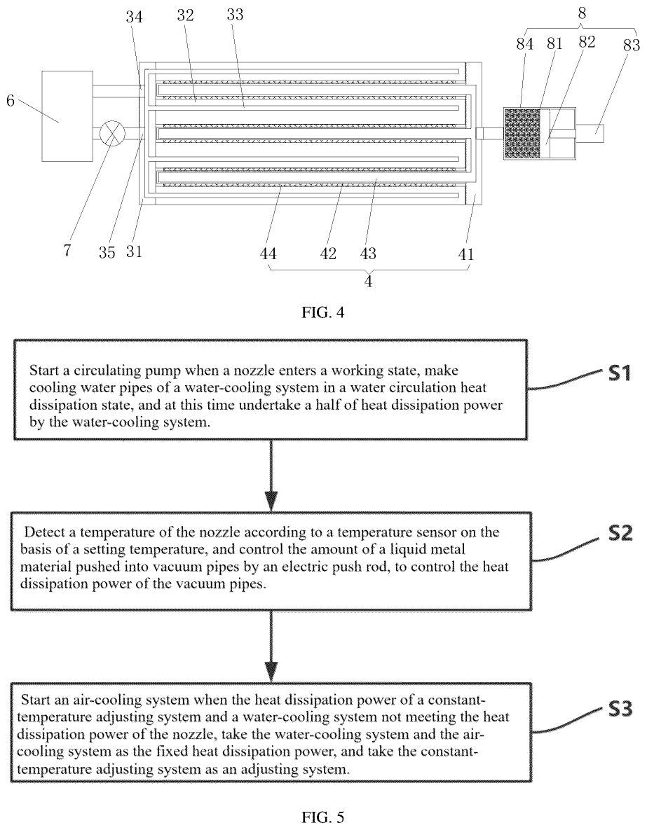

As shown in FIG. 4, the water circulation assembly includes a water tank 6 and a circulating pump 7 that are disposed on the base 1. The water-cooling horizontal bars 32 are internally provided with cooling water pipes 33 along length directions thereof, the cooling water pipes 33 are in snakelike arrangement, a plurality of cooling water pipes 33 are serially connected in heads and tails, a water inlet pipe 34 and a water outlet pipe 35 that are connected with heads and tails of the cooling water pipes 33 are disposed on the water-cooling side plate 31, the water tank 6, circulating pump 7 and water inlet pipe 34 are serially connected in turn, the water outlet pipe 35 is connected with the water tank 6, the water tank 6 can cool the heat therein by connecting an external cooler, and the cooler is the prior art. A half of heat of the nozzle 2 is taken away through water circulation.

Since the temperature of the nozzle 2 cannot be cooled to a low point completely, to remain the normal temperature of the nozzle 2, the other half of heat of the nozzle 2 is cooled by the constant-temperature adjusting system 4, the constant-temperature horizontal bars 42 are internally provided with vacuum pipes 43 along length directions thereof, a plurality of vacuum pipes 43 are connected with one main vacuum pipe in parallel, and the base 1 is provided with a constant-temperature adjusting assembly 8, which is used for adjusting the amount of a liquid metal material 84 squeezed into the vacuum pipes 43.

The constant-temperature adjusting assembly 8 includes a cylinder body 81, a piston 82 slidingly fitted in the cylinder body 81, and an electric push rod 83; and the cylinder body 81 is connected with a main pipe of the vacuum pipes 43, the liquid metal material 84 is filled in the cylinder body 81, and the electric push rod 83 is disposed on the cylinder body 81 and connected with the piston 82. The liquid metal material 84 is a gallium-base alloy.

Since the gallium-base alloy is corrosive to common metal, a layer of graphite-based corrosion resistant coating needs to be arranged on all the inner walls of the vacuum pipes 43 and the cylinder body 81 and the surface that the piston 82 is in contact with the liquid metal material 84 for corrosion protection, thus prolonging the service life of the device.

A processor connected with the temperature sensor is used for calculating real-time heat storage capacity. According to the temperature requirement of the nozzle 2, the piston 82 is controlled to push the liquid metal material 84 to enter or quit the vacuum pipes 43, to change the heat exchange area of the device and achieve the purpose of adjusting the heat release power, such that the temperature of the nozzle 2 can be kept at an expected state.

To increase the heat exchange effect between the constant-temperature horizontal bars 42 and the nozzle 2 as well as between the constant-temperature horizontal bars 42 and the water-cooling horizontal bars 32, surfaces that the exteriors of the constant-temperature horizontal bars 42 are in contact with the water-cooling horizontal bars 32 and the nozzle 2 are provided with heat dissipation fins 44. The heat dissipation fins 44 may be made of copper.

To make up a situation that the heat dissipation power of the constant-temperature adjusting system 4 and the water-cooling system 3 cannot meet the heat dissipation requirement of the nozzle 2, an air-cooling system 5 is covered outside the water-cooling system 3 and the constant-temperature adjusting system 4, the air-cooling system 5 includes an annular air cavity 51 and an air pump 9, the air cavity 51 is annularly covered outside the water-cooling horizontal bars 32 and the constant-temperature horizontal bars 42, an air inlet 52 and an air outlet 53 are provided on the air cavity 51, and the air pump 9 is connected with the air inlet 52. Dense through holes are provided at a position where an inner side wall of the air cavity 51 corresponds to the water-cooling horizontal bars 32 and the constant-temperature horizontal bars 42, and when the air pump 9 is running, the heat exchange efficiency with the water-cooling horizontal bars 32 and the constant-temperature horizontal bars 42 can be improved.

A using method of a digital printing machine nozzle refrigerating device is as shown in FIG. 5, and the method specifically includes the following steps:

S1: starting a circulating pump 7 when a nozzle 2 enters a working state, making cooling water pipes 34 of a water-cooling system 3 in a water circulation heat dissipation state, and at this time, undertaking a half of heat dissipation power of the nozzle 2 by the water-cooling system 3;

S2: detecting a temperature of the nozzle 2 according to a temperature sensor on the basis of a setting temperature, and controlling the amount of a liquid metal material 84 pushed into vacuum pipes 43 by an electric push rod 83, to control the heat dissipation power of the vacuum pipes 43; and

S3: starting an air-cooling system 5 when the heat dissipation power of a constant-temperature adjusting system 4 and a water-cooling system 3 not meeting the heat dissipation power of the nozzle 2, taking the water-cooling system 3 and the air-cooling system 5 as the fixed heat dissipation power, and taking the constant-temperature adjusting system 4 as an adjusting system.

Although the embodiments of the present disclosure have been presented and described, those of ordinary skill in the art may understand that various changes, modifications, replacements and deformations can be made to these embodiments without deviating from the principle of spirit of the present disclosure, and the scope of the present disclosure is defined by the appended claims and their equivalents.

What is claimed is:

1. A digital printing machine nozzle refrigerating device, comprising a base and a nozzle disposed on the base;
wherein a water-cooling system and a constant-temperature adjusting system are covered outside the nozzle, the water-cooling system comprises a water-cooling side plate and a plurality of water-cooling horizontal bars, the plurality of water-cooling horizontal bars are divided into two parts and horizontally disposed on both sides of the water-cooling side plate, the vertical water-cooling horizontal bars are arranged at intervals, and look-down sections of the water-cooling side plate and the water-cooling horizontal bars on both sides are U-shaped;
the constant-temperature adjusting system comprises a constant-temperature side plate and a plurality of constant-temperature horizontal bars, the plurality of constant-temperature horizontal bars are divided into two parts and horizontally disposed on both sides of the constant-temperature side plate, the vertical constant-temperature horizontal bars are arranged at intervals, and look-down sections of the constant-temperature side plate and the constant-temperature horizontal bars on both sides are U-shaped; and
the water-cooling horizontal bars and the constant-temperature horizontal bars are capable of being mutually plugged into each other's gaps, a water circulation assembly is disposed in the water-cooling horizontal bars, the constant-temperature horizontal bars are internally provided with vacuum pipes along length directions thereof, a constant-temperature adjusting assembly is disposed on the base, and the constant-temperature adjusting assembly is used for adjusting the amount of a liquid metal material squeezed into the vacuum pipes.

2. The digital printing machine nozzle refrigerating device according to claim 1, wherein the constant-temperature adjusting assembly comprises a cylinder body, a piston slidingly fitted in the cylinder body, and an electric push rod; and the cylinder body is connected with a main pipe of the vacuum pipes, the liquid metal material is filled in the cylinder body, and the electric push rod is disposed on the cylinder body and connected with the piston.

3. The digital printing machine nozzle refrigerating device according to claim 1, wherein surfaces that the exteriors of the constant-temperature horizontal bars are in contact with the water-cooling horizontal bars and the nozzle are provided with heat dissipation fins.

4. The digital printing machine nozzle refrigerating device according to claim 1, wherein the water circulation assembly comprises a water tank and a circulating pump, the water-cooling horizontal bars are internally provided with cooling water pipes along length directions thereof, a plurality of cooling water pipes are serially connected, a water inlet pipe and a water outlet pipe that are connected with heads and tails of the cooling water pipes are disposed on the water-cooling side plate, the water tank, circulating pump and water inlet pipe are serially connected in turn, and the water outlet pipe is connected with the water tank.

5. The digital printing machine nozzle refrigerating device according to claim 1, wherein an air-cooling system is covered outside the water-cooling system and the constant-temperature adjusting system, the air-cooling system comprises an annular air cavity and an air pump, the air cavity is annularly covered outside the water-cooling horizontal bars and the constant-temperature horizontal bars, an air inlet and an air outlet are provided on the air cavity, and the air pump is connected with the air inlet.

6. The digital printing machine nozzle refrigerating device according to claim 2, wherein the liquid metal material is a gallium-base alloy.

7. A using method of a digital printing machine nozzle refrigerating device according to claim 1, comprising:
S1: starting a circulating pump when a nozzle enters a working state, making cooling water pipes of a water-cooling system in a water circulation heat dissipation state, and at this time undertaking a half of heat dissipation power by the water-cooling system;
S2: detecting a temperature of the nozzle according to a temperature sensor on the basis of a setting temperature, and controlling the amount of a liquid metal material pushed into vacuum pipes by an electric push rod, to control the heat dissipation power of the vacuum pipes; and
S3: starting an air-cooling system when the heat dissipation power of a constant-temperature adjusting system and a water-cooling system not meeting the heat dissipation power of the nozzle, taking the water-cooling system and the air-cooling system as the fixed heat dissipation power, and taking the constant-temperature adjusting system as an adjusting system.
